(19) United States
(12) Patent Application Publication
(10) Pub. No.: US 2020/0210327 A1
(43) Pub. Date: Jul. 2, 2020

(54) M2M APPLICATION TEST DEVICE AND METHOD

(71) Applicants: INDUSTRY-ACADEMIA COOPERATION GROUP OF SEJONG UNIVERSITY, Seoul (KR); KOREA ELECTRONICS TECHNOLOGY INSTITUTE, Seongnam-si (KR)

(72) Inventors: Jae Seung SONG, Seongnam-si (KR); Jae Young HWANG, Seoul (KR); Seung Myeong JEONG, Seongnam-si (KR); Jae Ho KIM, Seongnam-si (KR)

(21) Appl. No.: 16/339,859

(22) PCT Filed: Sep. 29, 2017
(86) PCT No.: PCT/KR2017/010975

§ 371 Date: Dec. 23, 2019

(30) Foreign Application Priority Data
Oct. 6, 2016 (KR) 10-2016-0129261
Mar. 16, 2017 (KR) 10-2017-0033378

(51) Int. Cl. G06F 11/36; G06F 9/445; H04L 29/08

(52) U.S. Cl. CPC G06F 11/3688; G06F 11/3692; H04L 67/1097; G06F 9/44505; G06F 11/3684

(57) ABSTRACT

An M2M application test apparatus and method are disclosed. According to one embodiment of the present invention, the M2M application test apparatus for testing an M2M application on the basis of a one M2M standard can comprise: an application storage for storing at least one application to be tested; and at least one server, which configures a test triggering message on the basis of the application to be tested and test-related information so as to transmit the test triggering message to the application to be tested, and receives a test result from the application to be tested and provides the same.

### TECHNICAL FIELD

The present invention relates to a machine-to-machine (M2M) application test device and method, and more specifically, to an M2M application test device and method on the basis of the one M2M standard.

### BACKGROUND ART

Various standards have been proposed as Internet of Things (IoT) application standards that are widely used in fields such as smart homes, health cares, industries, and the like. One M2M, which is a standardization organization formed by eight major global standard developing operations (SDOs) since 2012 to solve interoperability problems among various IoT standards under development, aims for a global standard for interworking and sharing information among various IoT devices connected to the Internet and is developing a standard for functions of a common service layer commonly required by all IoT devices and servers.

In the IoT market, device-based development is becoming more active than development of IoT servers and gateways, and standard testing methodologies based on servers and gateways have been proposed. Thus, all of the testing methodologies based on the existing one M2M standard have only conformance test cases and methodologies for architectures used in servers and gateways as conformance tests for Infrastructure Node (MN), Middle Node (MN) and Application Service Node (ASN). However, there is a limitation in that a server and gateway based testing methodology alone cannot build a complete one M2M standard ecosystem.

### DISCLOSURE

### Technical Problem

An objective of the present invention is to provide a machine-to-machine (M2M) application test apparatus capable of solving the absence of test cases and methodology for an Application Dedicated Node (ADN).

Another objective of the present invention is to solve the above-described problem and to provide an M2M application test method used by an M2M application test apparatus.

### Technical Solution

According to one embodiment of the present invention, an apparatus for testing machine-to-machine (M2M) application on the basis of the one M2M standard may include an application storage configured to store at least one test target application and at least one server configured to configure a test triggering message on the basis of the test target application and test-related information, transmit the test triggering message to the test target application, receive a test result from the test target application, and provide the test result.

The test triggering message may include at least one of information related to a test operation, information related to a resource type for which a test operation is performed, and information related to an address of a target resource.

The test operation may include at least one of Create, Retrieve, Update, and Delete commands based on the one M2M standard.

The test triggering message may be configured using Hypertext Transfer Protocol (HTTP) and JavaScript Object Notation (JSON).

The server may use a testing tool implemented in accordance with Testing and Test Control Notation version3 (TTCN-3).

The at least one server may include a first web server configured to receive the test target application, store the application in the application storage, transmit information related to a test scheme to a second web server, receive the test result from the second web server, and provide the test result to a user and the second web server configured to create a configuration file on the basis of the information related to the test scheme and run a testing tool on the basis of the configuration file.

The test triggering message may generated by the testing tool executed by the second web server.

According to another embodiment of the present invention, an M2M application test method may include receiving and storing a test target application and test-related information, configuring a test triggering message on the basis of the test-related information and the test target application, transmitting the test triggering message to the test target application, and receiving a test result from the test target application and providing the test result.

The configuring of the test triggering message on the basis of the test-related information and the test target application may include creating a configuration file on the basis of information related to a test scheme, running a testing tool on the basis of the configuration file, and generating the triggering message using the testing tool.

The testing tool may be implemented in accordance with TTCN-3.

According to still another embodiment of the present invention, a machine-to-machine (M2M) device may include a memory in which at least one application is stored and at least one processor configured to execute the at least one application stored in the memory.

Here, the at least one application may include an upper tester application (UTA) configured to receive a test triggering message from a device for testing an M2M application on the basis of a one M2M standard, determine which test is to be performed by parsing the test triggering message, and request a test target application to perform an operation suitable for a corresponding test and include the test target application (Implementation Under Test (ITU)) configured to execute a command requested by the UTA on the basis of an Application Dedicated Node (ADN) profile and transmit execution result-related data to the apparatus for testing an M2M application.

### Advantageous Effects

According to one embodiment of the present invention, an authority responsible for authentication of a one M2M terminal or application is allowed to perform an easy authentication operation.

In addition, by providing a testing tool, such as a web-based test system, it is possible to perform a self-test even before formal certification by a certification authority, thereby providing a high degree of completeness in supporting a one M2M standard of an application.

### DESCRIPTION OF DRAWINGS

FIG. 1 is a diagram illustrating a structure between an application and a test system according to one embodiment of the present invention.

FIG. 2 is a diagram illustrating a concept of a web-based machine-to-machine (M2M) application test method according to one embodiment of the present invention.

FIG. 3 is a diagram illustrating a user interface screen provided by a web-based test system according to one embodiment of the present invention.

FIG. 4 is a diagram illustrating a user interface screen provided by a web-based application test system according to another embodiment of the present invention.

FIG. 5 is a simplified flowchart of an application test method according to one embodiment of the present invention.

FIG. 6 is a detailed block diagram illustrating a configuration of a test system according to one embodiment of the present invention.

FIG. 7 is a diagram illustrating a triggering message structure according to one embodiment of the present invention.

FIG. 8 is a diagram illustrating one embodiment of an operation parameter value included in a triggering message of the present invention and interpretation thereof.

FIG. 9 is a diagram illustrating one embodiment of a resource type value included in a triggering message of the present invention and implementation thereof.

FIG. 10 is a diagram illustrating a binary format of a triggering message according to another embodiment of the present invention.

FIG. 11 is a mapping table of one M2M resources and a triggering message according to another embodiment of the present invention.

FIG. 12 is a diagram illustrating a JavaScript Object Notation (JSON) format of a triggering message according to another embodiment of the present invention.

FIG. 13 is a table showing an Application Dedicated Node (ADN) profile according to one embodiment of the present invention.

FIG. 14 is a table showing an ADN profile according to another embodiment of the present invention.

FIG. 15 is a table showing an ADN profile according to still another embodiment of the present invention.

FIG. 16 is an operation flowchart of an M2M application test method according to one embodiment of the present invention.

### MODES OF THE INVENTION

Since the present invention may be modified in various forms and may have various embodiments, the following exemplary embodiments are illustrated in the accompanying drawings and are described in detail with reference to the drawings. However, this is not intended to limit the present invention to specific embodiments, and the present invention should be construed to encompass various changes, equivalents, and substitutions within the technical scope and spirit of the invention.

It will be understood that although the terms first, second, etc. may be used herein to describe various elements, these elements should not be limited by these terms. These terms are only used to distinguish one element from another. For example, a first element could be termed a second element, and, similarly, a second element could be termed a first element without departing from the scope of the present invention. As used herein, the term “and/or” includes any one or a combination of a plurality of the associated listed items.

It will be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention seeks to improve completeness in supporting a one M2M standard of a one M2M application by providing a device and method for testing a one M2M application.

Hereinafter, exemplary embodiments according to the present invention will be described in detail with reference to the accompanying drawings.

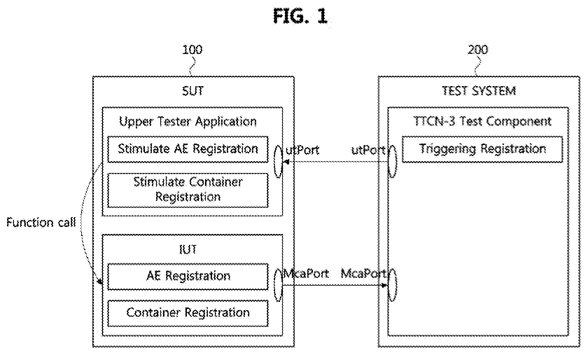

FIG. 1 is a diagram illustrating a structure between an application and a test system according to one embodiment of the present invention.

In FIG. 1, a system under test (SUT) 100 may refer to an M2M application (SUT) 100 to be tested and a test apparatus 200 is a device for testing a test target. Here, the M2M application may be an application that complies with the one M2M standard.

The test apparatus 200 transmits a minimum amount of information so that the one M2M application to be tested can perform a specific function for performing the test, wherein a message to be transmitted is an upper tester triggering message. The upper tester triggering message is a message used to deliver a control command between the test system 200 and an upper tester application (UTA) of the SUT 100 and plays an important role in an application test system according to the present invention with regard to what information is to be transmitted to a device to perform a test case.

The SUT 100 may include a UTA and an implementation under test (IUT) which is an application to be actually tested. In addition, the SUT 100 may be a concept that includes at least one device under test (DUT) which is a combination of software and hardware items.

In other words, the SUT 100 may be an M2M device or terminal that includes a device as well as an application. The M2M device according to one embodiment of the present invention may include a UTA and a test target application.

The M2M device according to one embodiment of the present invention may also include a memory, in which at least one application is stored, and at least one processor configured to execute the at least one application stored in the memory.

Here, the at least one application may include a UTA that receives a test triggering message from a device for testing the M2M application on the basis of the one M2M standard, determines which test is to be performed by parsing the test triggering message, and requests a test target application to perform an operation suitable for the corresponding test and an IUT that executes a command requested by the tester application on the basis of an Application Dedicated Node (ADN) profile and transmits data related to a test result to the apparatus for testing the M2M application.

The tester application may receive a triggering message transmitted from the test system, determine which test is to be run by parsing, that is, analyzing, the message, and request the IUT to perform a function suitable for a corresponding test. For example, as shown in the drawing, commands, such as an application entity (AE) registration request and container registration, may be executed, and the commands includes Create, Retrieve, Update, and Delete (CRUD) commands executable by all ADNs configured based on ADN profiles defined in the TS-0025 definition of product profile. The IUT performs a function, such as AE registration, container registration, and the like, or a command. The IUT included in the SUT is a system accessible only through the SUT and a communication with the test system may be performed through the SUT.

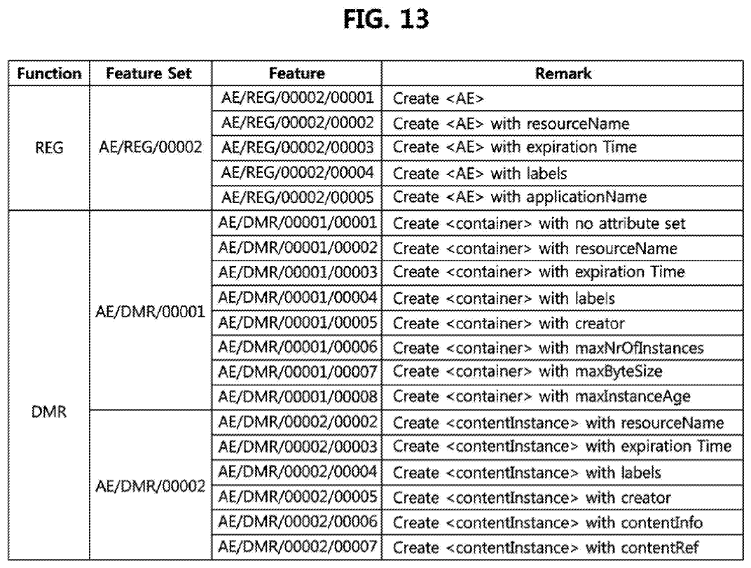

In this case, information to be executed is based on the ADN profile that defines specifications to be implemented by the one M2M application. The ADN refers to a node that contains at least one AE and does not contain a common service entity (CSE). The ADN may or may not be preset in a field domain of a one M2M system and the ADN may be positioned within a limited M1M device. An embodiment of the ADN profile will be described below with reference to FIGS. 13 to 15.

The one M2M application to be tested, that is, the IUT which has received the test information, executes the command requested by the test system 200 on the basis of the test information, and the test system 200 that receives execution result related-data determines through the result data whether the corresponding application has been implemented in compliance with the one M2M standard.

Meanwhile, the SUT 100 and the test system 200 may communicate with each other through a Mca port for a communication flow between the AE and the CSE. When the SUT including a general CSE is tested, the test system serves as an AE and the SUT serves as a server or gateway. However, the roles are reversed when the AE that does not include the CSE, that is, the ADN is tested. The SUT 100 may be, for example, an application entity, and the test system may be in the form of a common service entity, for example, a server.

Meanwhile, the UTA of the SUT 100 and a Testing and Test Control Notation version 3 (TTCN-3) test component may be connected to an upper tester port (utPort). The test system supporting TTCN-3 language refers to a test system that supports compiling of the TCCN-3 language, which is a core function, with a native language (e.g., C++, Java, C, and the like). TCCN-3 is a language specialized for testing which describes procedures for how the testing should be performed, but TCCN-3 only describes the procedures and is not actually communicative code. Thus, in order to substantially perform a communication with the SUT, code described in the TTCN-3 has to be converted into native code and a compiler's way of compiling the TTCN-3 varies depending on each tool vendor.

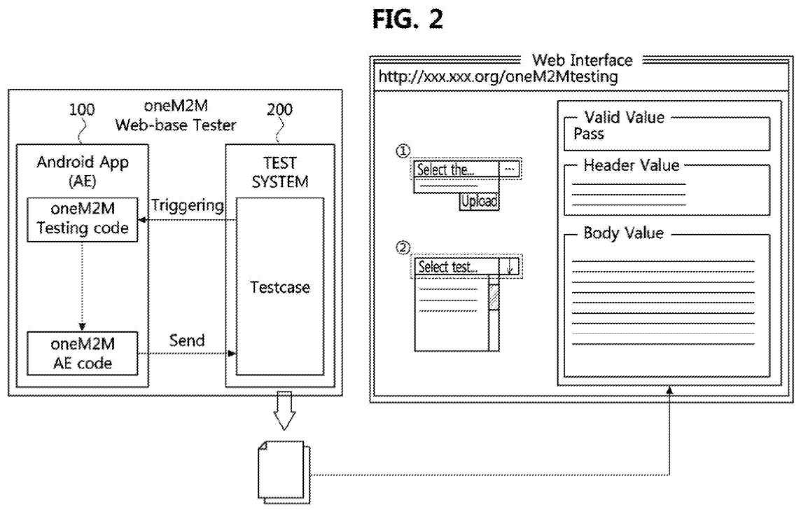

FIG. 2 is a diagram illustrating a concept of a web-based M2M application test method according to one embodiment of the present invention.

The present invention provides a web-based test system 200 for providing a one M2M application test.

A user intending to run a test uploads an application 100 to be tested through a web-page provided by the test system and inputs information (e.g., AE registration, container registration, and the like) related to a test case to be tested.

The web-based test system 200 configures a triggering message according to the information input by the user and transmits the same to the application 100 to be tested. The application runs a test using testing code (e.g., runs one M2M AE code) and transmits a test execution result to the test system 200. The test system 200 analyzes the test execution result and displays an analysis result on a web-page. The result represented on the web-page may include a test pass valid value, a header value, and a body value.

Here, the test system 200 is configured to be enabled to run a test using standard test cases (abstract test suites) written by European Telecommunications Standards Institute (ETSI) on the basis of Tree and Tabular Combined Notation version 3 (TTCN-3) language according to the one M2M standard and check whether implementation is done in compliance with the one M2M standard by checking result data for Create, Retrieve, Update, and Delete commands, which are test commands sent by the one M2M application.

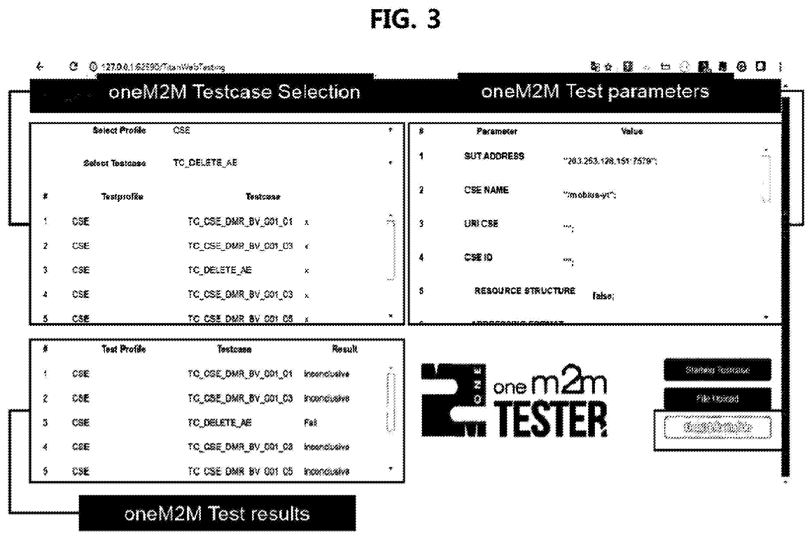

FIG. 3 is a diagram illustrating a user interface screen provided by a web-based test system according to one embodiment of the present invention.

The screen according to the embodiment of FIG. 3 includes largely three items, a one M2M test case selection section (one M2M Testcase Selection) for selecting a test case, a one M2M test parameter section (one M2M Test parameters), and a one M2M test result section (one M2M Test results) showing a test result.

That is, when the user inputs test information through the one M2M test case selection section and the one M2M test parameter section, a result may be confirmed through the one M2M test result section.

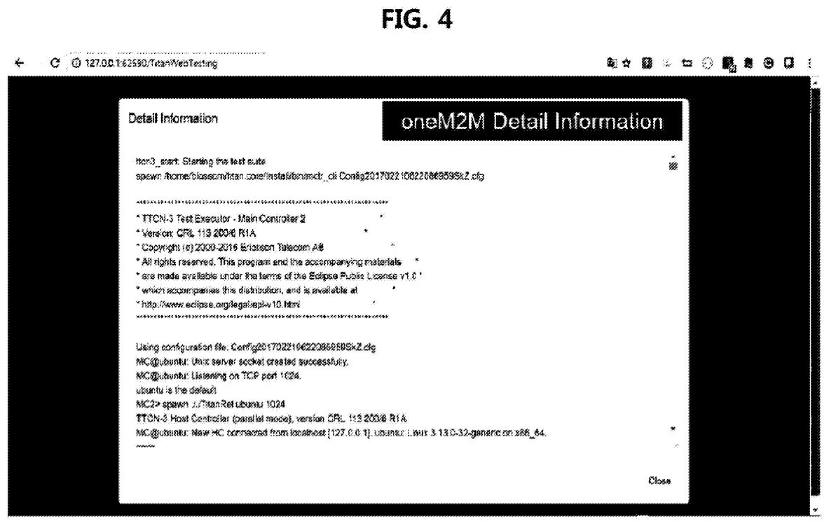

FIG. 4 is a diagram illustrating a user interface screen provided by a web-based application test system according to another embodiment of the present invention.

The screen shown in FIG. 4 is a screen that shows a one M2M test result in detail. The screen of FIG. 4 shows information regarding which testing tool is used to run a test, detailed information on a test result, and the like.

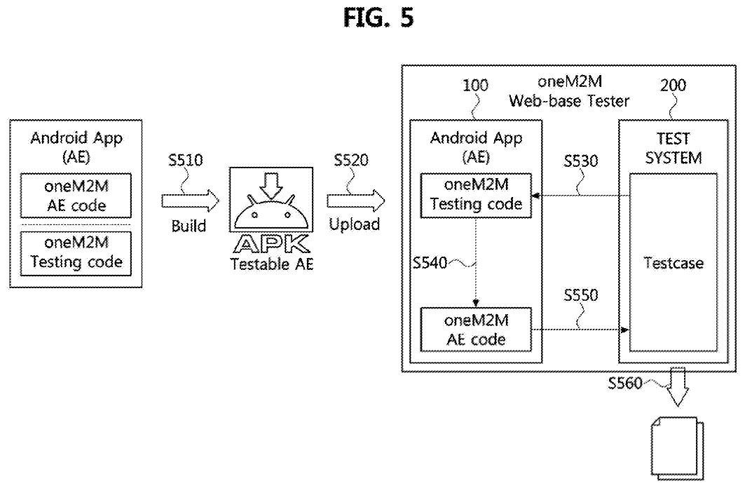

FIG. 5 is a simplified flowchart of an application test method according to one embodiment of the present invention.

According to an M2M application test method according to one embodiment of the present invention, when a user uploads an application (.apk) to be tested to a test system 200, the test system internally executes the application (for example, by using an emulator) and then informs the user of a test result after testing the application. A schematic flow of the M2M application test method according to one embodiment of the present invention is as shown in FIG. 5.

A one M2M application in which one M2M testing code developed by a user, for example, an M2M application developer, in compliance with an ADN profile is implemented (included) is built (S510), and the one M2M application (.apk) is uploaded to a web-based test system (S520). When the user determines a method for performing a test on the uploaded application, the test system 200 configures a triggering message in accordance with the method and transmits the same to the one M2M application (S530). The one M2M application receives and analyzes the triggering message using one M2M testing code, determines an operation of the one M2M application according to analyzed internal information, and executes one M2M AE code designated by the user or one M2M CRUD code (S540). An execution result is provided to the test system 200 (S550), and the user may check a test result through a user interface screen provided by the test system 200 (S560).

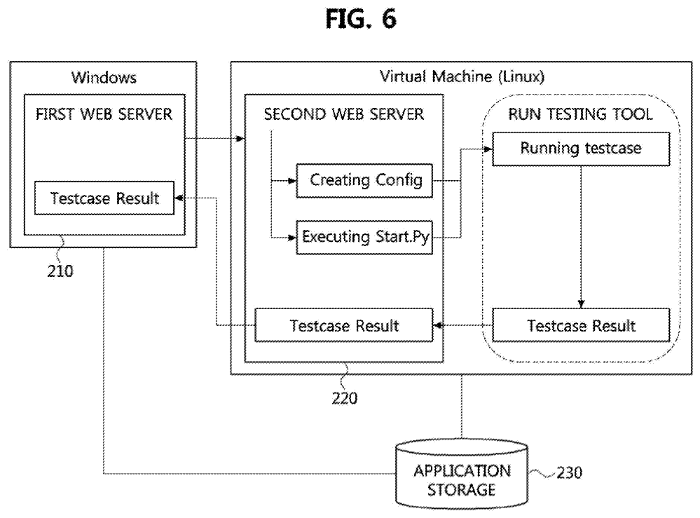

FIG. 6 is a detailed block diagram illustrating a configuration of a test system according to one embodiment of the present invention.

As shown in FIG. 6, a test apparatus or system according to one embodiment of the present invention may include a first web server 210, a second web server 220, and an application storage 230.

The first web server 210 may be a main web server that drives Windows for providing a user interface or the like. The second web server 220 may be a sub-web server that performs an actual test by running a testing tool. The second web server 220 may be configured to include a plurality of servers to multi-task a plurality of tests when a plurality of test requests are received and may be implemented in the form of a virtual machine.

In addition, as shown in the embodiment illustrated in FIG. 6, the first web server 210 and the second web server 220 may be separately provided and may be implemented as one server incorporating functions of the two servers. In this case, the server according to the present invention may configure a test triggering message on the basis of a test target application and test-related information, transmit the test triggering message to the test target application, receive a test result from the test target application, and transmit the test result to the user.

The server according to the present invention may be configured to include at least one processor and a memory in which commands instructing the at least one processor to perform at least one operation are stored. Here, the at least one operation may include receiving and storing a test target application and test-related information, configuring a test triggering message on the basis of the input test-related information and the stored test target application; transmitting the test triggering message to the test target application; and receiving a test result from the test target application and providing the test result.

More specifically, the first web server 210 receives an image or code of the test target application and stores the same in the application storage 230. The first web server 210 also transmits information related to a test scheme input by the user to the second web server 220 which performs an actual test.

The second web server 220 which is a test execution server creates a configuration file for performing a test on the basis of the information input by the user (Creating Config in FIG. 6). Here, the configuration file may include a test target application support protocol, serialization information, profile information, and the like. After the configuration file is created, the second web server 220 may run a script program to run a testing tool on the basis of the configuration file (Executing Start.Py in FIG. 6). A test triggering message may be generated by the testing tool.

In addition, for example, Eclipse Titan, which supports compiling of TTCN-3, may be used as a testing tool.

The testing tool may select a suitable test case on the basis of data recorded in the configuration file, prepare to run the test case, and perform a test through running the test case. A test result is transmitted to the first web server 210 via the second web server 220 which is a test execution server. The first web server 210 ultimately transmits the test execution result to the user.

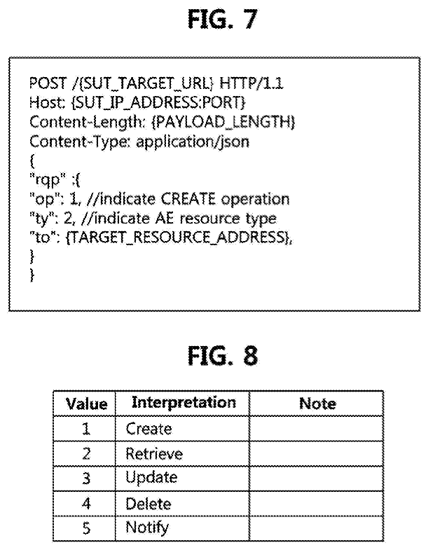

A structure of a triggering message according to the present invention will be described in detail with reference to FIGS. 7 to 9.

FIG. 7 is a diagram illustrating a triggering message structure according to one embodiment of the present invention.

FIG. 7 illustrates an example of a triggering message which is configured using Hypertext Transfer Protocol (HTTP) and JavaScript Object Notation (JSON). The message shown in FIG. 7 is in the form in which request primitive (requestPrimitive (rqp)) according to the one M2M standard is included in a HTTP message payload.

As shown in FIG. 7, information to be contained in the triggering message is an operation (op), a resource type (ty), a target resource address (to) operation, or the like.

The operation (op) information is mandatory information that has to be contained in the triggering message and may define a type of test operation. The operation may include CRUD operations including Create, Retrieve, Update, and Delete commands. By specifying an operation command using the operation information (or parameter), it may be indicated which command is to be executed by a one M2M application.

The resource type (ty) is also mandatory information that has to be contained in the triggering message and indicates for which resource a test operation is to be performed. That is, the resource type determines for which resource the CRUD operations is to be performed. For example, in one M2M standard resources that an ADN can handle, resources, such as an AE and contentInstance which are at an AE level or lower, are included.

The target resource address (to) is also mandatory information that has to be contained in the triggering message and refers to an address of a target resource that is a target of an operation. Since a device which has received the triggering message has to be able to transmit CRUD information regarding the one M2M standard implemented by the device back to the test system, an address of the test system may be used as the target resource address (to).

The triggering message may further contain primitive content (PrimitiveContent (pc)) information, and the primitive content information is not mandatory information but optional information. Additional information regarding the corresponding target resource may be provided to Create and Update commands among the above-described operations except for Retrieve and Delete commands.

For example, additional information may be provided when a resource name for distinguishing resources at the time of generating the resources and data measured by a sensor are stored or when a resource is newly updated.

FIG. 8 is a diagram illustrating one embodiment of an operation parameter value included in a triggering message of the present invention and interpretation thereof.

Referring to FIG. 8, when an operation parameter value is “1,” it may indicate a “Create” command among CRUD operations, and when the operation parameter value is “2,” it may indicate a “Retrieve” command. In addition, when the operation parameter value is “3,” it may indicate an “Update” command among CRUD operations, when the operation parameter value is “4,” it may indicate a “Delete” command, and when the operation parameter value is “5,” it may indicate a “Notify” command.

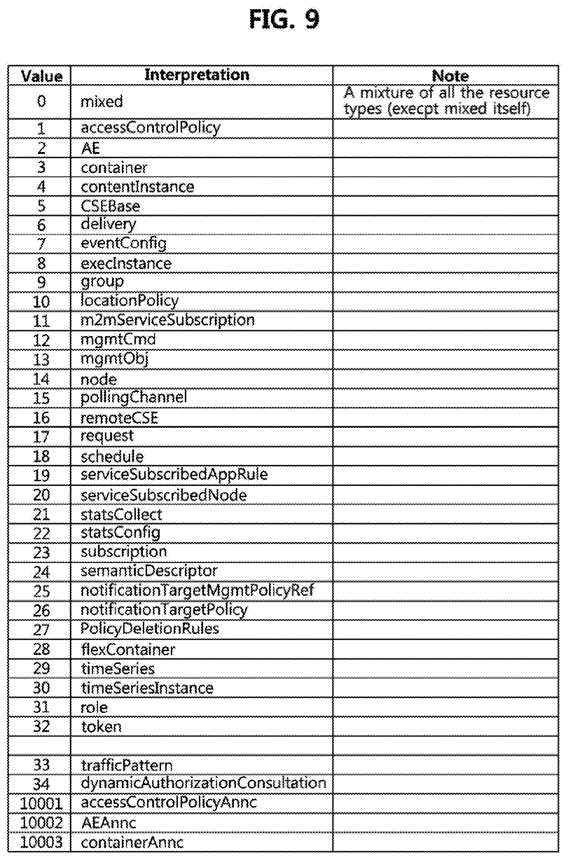

FIG. 9 is a diagram illustrating one embodiment of a resource type value included in a triggering message of the present invention and implementation thereof.

As shown in FIG. 9, there may be several tens of resource types. When a resource type parameter has a value of “0,” a mixed resource type may be indicated. When the resource type parameter has a value of “1,” “accessControlPolicy” may be indicated, when the resource type parameter has a value of “2,” “AE” may be indicated and when the resource type parameter has a value of “3,” “container” may be indicated.

Meanwhile, in order to transmit a triggering message, a method of transmitting a triggering message through a socket communication (after establishing a simple transmission control protocol (TCP) connection, a message is transmitted in a pre-defined format) and a method of configuring a message using a JSON format and a protocol (HTTP, MQTT, CoAP) of an application layer higher than the layer of a socket communication and transmitting the same may be used. Both of the two methods commonly include a minimal data set required by a test system and a device for conformance testing.

In the present invention, in addition to the triggering message in the form shown in FIG. 7, two other triggering message concepts for identifying a device state may be included.

That is, the triggering message according to the present invention may include a start triggering message and a termination triggering message.

The start triggering message may be used to check whether a device is able to run a specific test case. For example, since some devices may not be able to run a specific test case sent by a test system, the test system may send a start triggering message to a device in advance and check whether the device can run the corresponding test case.

The termination triggering message may be used to notify a test system that a device has completed a specific test case.

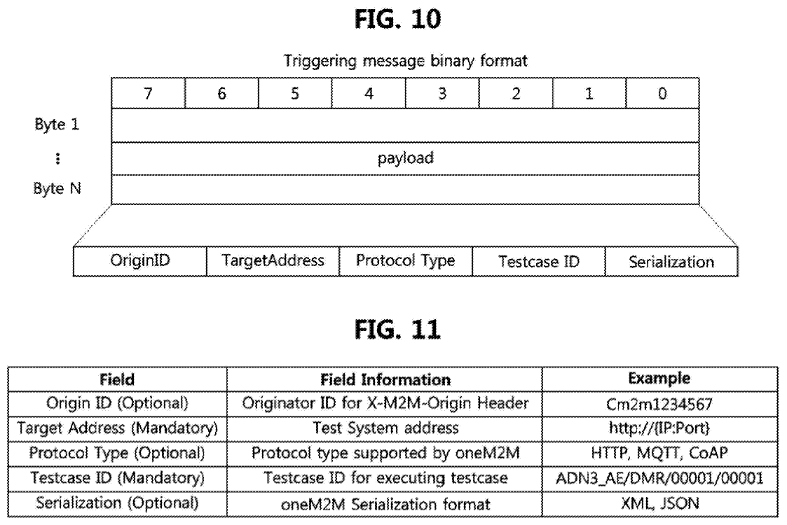

FIG. 10 is a diagram illustrating a binary format of a triggering message according to another embodiment of the present invention.

A message shown in FIG. 10 is a TCP layer-based triggering message, which includes an origin ID, a target address, a protocol type, a test case ID, and a serialization parameter.

FIG. 11 is a mapping table of one M2M resources and a triggering message according to another embodiment of the present invention.

The mapping table shown in FIG. 11 is related to an application layer-based triggering message using JSON. The configuration of the triggering message according to another embodiment of the present invention is shown in FIG. 11, and detailed information on each parameter of the triggering message is shown below.

Origin ID

The one M2M standard has a resource called “AccessControlPolicy” which is responsible for security policies of one M2M. When an AE is registered in a CSE, the CSE issues a specific origin ID in response to the registration. When Container or content Instance is further registered as CRUD for the AE or as a sub-resource for the AE, CRUD commands may be performed according to the security policies only when the previously issued origin ID is input to X-M2M-Origin header. Therefore, in order to test the AE, the origin ID has to be included when the AE sends a message for the test, and hence the origin ID is transmitted through a triggering message.

Target Address

A device which has received the triggering message has to be able to transmit CRUD information regarding a one M2M standard implemented by the device back to the test system. In this case, a target address, which is an address of the test system, may be used. The target address may additionally include port information or the like.

Protocol Type

One M2M supports three types of protocols, HTTP, MQTT, and CoAP, as shown in FIG. 8. Hence, it is possible to select a specific protocol and confirm whether a one M2M application has been implemented with respect to the corresponding protocol. This process may be omitted when the corresponding information is already checked by a user at the time of creating a configuration file.

Testcase ID

A Testcase ID indicates which test case is to be performed, and a one M2M application may perform a test specified by the testcase ID. That is, when an AE receives a testcase ID, the AE is allowed to confirm which function the test system intends to test and transmits an AE message corresponding to the testcase ID to the test system.

For example, when the test system intends to test a registration operation of the AE, the test system sends a testcase ID (AE/REG/00002/00001) which corresponds to AE registration. The AE analyzes and understands the testcase ID, receives the triggering message, sends an AE registration message corresponding to the triggering message to the test server. Here, as the testcase ID, a testcase ID defined by an actual one M2M testing standard may be used, but a specific number is allocated to each ID by applying enumeration and a corresponding number may be transmitted in order to reduce a length of a message. That is, in the case of a current testcase ID, a name of the testcase ID may be used without change in the above-described method (e.g., ADN3_AE/DMR/00001/00001), and also a specific number may be allocated (applying enumeration) according to classification of each test case and used.

Serialization

one M2M supports two types of message formats (XML and JSON) as shown in FIG. 8, and a serialization parameter is a parameter that indicates which message format is used between the two message formats. Through the serialization parameter, a specific message format in which one M2M data is combined and transmitted by a one M2M application may be confirmed.

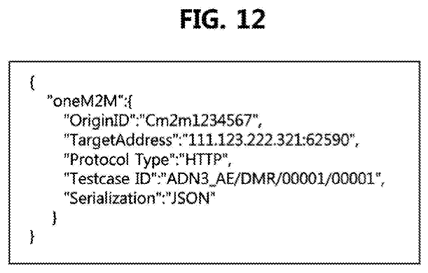

FIG. 12 is a diagram illustrating a JSON format of a triggering message according to another embodiment of the present invention. It is seen that the triggering message shown in FIG. 12 includes an origin ID, a target address, a protocol type, a testcase ID, and serialization parameters.

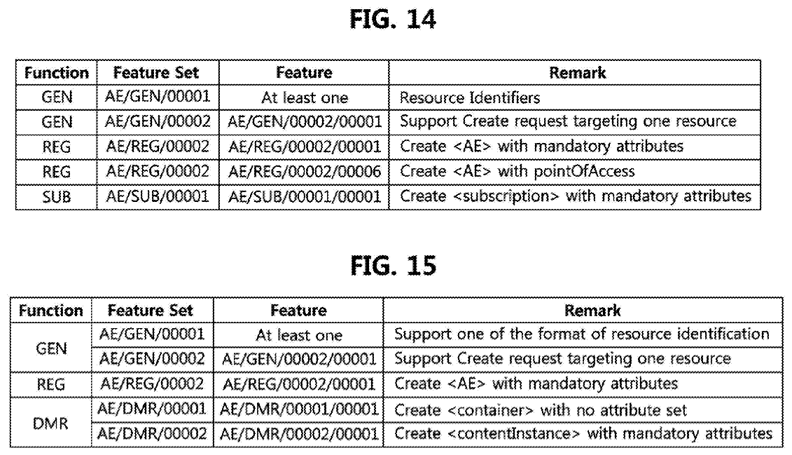

FIG. 13 is a table showing an ADN profile according to one embodiment of the present invention, FIG. 14 is a table showing an ADN profile according to another embodiment of the present invention, and FIG. 15 is a table showing an ADN profile according to still another embodiment of the present invention.

An ADN profile defines specifications to be implemented by a one M2M application and through the embodiments of FIGS. 13 to 15, it is confirmed that the form of ADN profile includes “Function,” “Feature Set,” “Feature,” and “Remark” items.

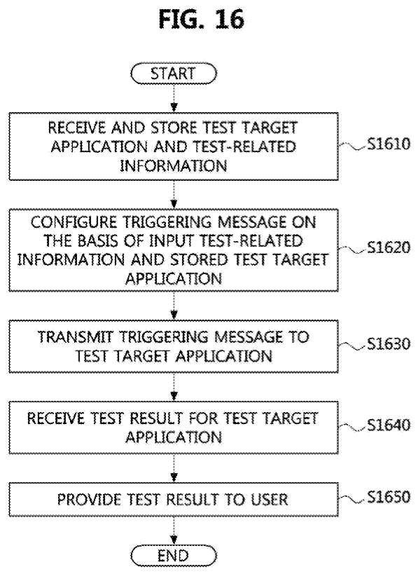

FIG. 16 is an operation flowchart of an M2M application test method according to one embodiment of the present invention.

The M2M application test method according to one embodiment of the present invention may be performed by the above-described M2M application test apparatus 200, but a subject of the operation is not limited thereto and may be a web server included in the M2M application test apparatus 200.

Referring to FIG. 16, the M2M application test method according to the present invention receives a test target application and test-related information and stores the test target application and test-related information (S1610) and configures a triggering message on the basis of the input test-related information and the stored test target application (S1620). Here, the operation S1620 of configuring the triggering message may include generating a configuration file on the basis of information related to a test scheme, running a testing tool on the basis of the configuration file, and generating a triggering message using the testing tool.

Then, the test apparatus transmits the test triggering message to the test target application (S1630), receives a test result from the test target application (S1640), and then provides the test result to a user (S1650).

The method according to the embodiments of the present invention may also be embodied as computer readable programs or codes on a computer readable recording medium. The computer readable recording medium is any data storage device that may store data which can be thereafter read by a computer system. The computer readable recording medium may also be distributed over network coupled computer systems so that the computer readable code is stored and executed in a distributed fashion.

In addition, examples of the computer-readable recording medium may include magnetic media such as hard discs, floppy discs, and magnetic tapes, optical media such as compact disc-read-only memories (CD-ROMs), digital video disc (DVDs), and so on, magneto-optical media such as floptical discs, and hardware devices specially configured (or designed) for storing and executing program commands, such as ROMs, random access memories (RAMs), flash memories, and so on. Examples of a program command may not only include machine language codes, which are created by a compiler, but may also include high-level language codes, which may be executed by a computer using an interpreter, and so on.

Some aspects of the present invention have been described in the context of an apparatus but may also represent the corresponding method. Here, a block or the apparatus corresponds to an operation of the method or a characteristic of an operation of the method. Likewise, aspects which have been described in the context of the method may be indicated by the corresponding blocks or items or characteristics of the corresponding apparatus. Some or all of operations of the method may be performed by (or using) a hardware device, such as a microprocessor, a programmable computer, or an electronic circuit. In some embodiments, one or more important steps of the method may be performed by such a device.

In the exemplary embodiments of the present invention, a programmable logic device (e.g., a field-programmable gate array (FPGA)) may be used to perform some or all of functions of the above-described methods. In the exemplary embodiments, the FPGA may operate in combination with a microprocessor for performing one of the above-described methods. In general, the methods may be performed by any hardware device.

While the exemplary embodiments of the present invention and their advantages have been described in detail, it should be understood that various changes, substitutions and alterations may be made herein without departing from the scope of the invention.

What is claimed is:

1. Apparatus for testing a machine-to-machine (M2M) application on the basis of the one M2M standard, comprising:
an application storage configured to store at least one test target application; and
at least one server configured to configure a test triggering message on the basis of the test target application and test-related information, transmit the test triggering message to the test target application, receive a test result from the test target application, and provide the test result.

2. The apparatus of claim 1, wherein the test triggering message includes at least one of information related to a test operation, information related to a resource type for which a test operation is performed, and information related to an address of a target resource.

3. The apparatus of claim 2, wherein the test operation includes at least one of Create, Retrieve, Update, and Delete commands based on the one M2M standard.

4. The apparatus of claim 1, wherein the test triggering message is configured using Hypertext Transfer Protocol (HTTP) and JavaScript Object Notation (JSON).

5. The apparatus of claim 1, wherein the server uses a testing tool implemented in accordance with Testing and Test Control Notation version 3 (TTCN-3).

6. The apparatus of claim 1, wherein the at least one server includes:
a first web server configured to receive the test target application, store the application in the application storage, transmit information related to a test scheme to a second web server, receive the test result from the second web server, and provide the test result to a user; and
the second web server configured to create a configuration file on the basis of the information related to the test scheme and run a testing tool on the basis of the configuration file.

7. The apparatus of claim 6, wherein the test triggering message is generated by the testing tool executed by the second web server.

8. A method for testing a machine-to-machine (M2M) application comprising:
receiving and storing a test target application and test-related information;
configuring a test triggering message on the basis of the test-related information and the test target application;
transmitting the test triggering message to the test target application; and
receiving a test result from the test target application and providing the test result.

9. The method of claim 8, wherein the configuring of the test triggering message on the basis of the test-related information and the test target application comprises:
creating a configuration file on the basis of information related to a test scheme;
running a testing tool on the basis of the configuration file; and
generating the triggering message using the testing tool.

10. The method of claim 8, wherein the test triggering message includes at least one of information related to a test operation, information related to a resource type for which a test operation is performed, and information related to an address of a target resource.

11. The method of claim 10, wherein the test operation includes at least one of Create, Retrieve, Update, and Delete commands based on a one M2M standard.

12. The method of claim 8, wherein the test triggering message is configured using Hypertext Transfer Protocol (HTTP) and JavaScript Object Notation (JSON).

13. The method of claim 9, wherein the testing tool is implemented in accordance with Testing and Test Control Notation version 3 (TTCN-3).

14. A machine-to-machine (M2M) device comprising:
a memory in which at least one application is stored; and
at least one processor configured to execute the at least one application stored in the memory,
wherein the at least one application includes:
an upper tester application (UTA) configured to receive a test triggering message from an apparatus for testing an M2M application on the basis of a one M2M standard, determine which test is to be performed by parsing the test triggering message, and request a test target application to perform an operation suitable for a corresponding test; and
the test target application (Implementation Under Test (ITU)) configured to execute a command requested by the UTA on the basis of an Application Dedicated Node (ADN) profile and transmit execution result-related data to the apparatus for testing an M2M application.

15. The M2M device of claim 14, wherein the test triggering message includes at least one of information related to a test operation, information related to a resource type for which a test operation is performed, and information related to an address of a target resource.

16. The M2M device of claim 15, wherein the test operation includes at least one of Create, Retrieve, Update, and Delete commands based on the one M2M standard.

17. The M2M device of claim 14, wherein the test triggering message is configured using Hypertext Transfer Protocol (HTTP) and JavaScript Object Notation (JSON).
